(19) United States
(12) Patent Application Publication
(10) Pub. No.: US 2009/0321526 A1
(43) Pub. Date: Dec. 31, 2009

(54) CABLE HOUSING UNIT, SCANNER SYSTEM, CHECKOUT SYSTEM AND INSTALL METHOD

(75) Inventors: Yukiko Yokoyama, Shizuoka (JP); Tatsuya Ikegami, Tokyo (JP); Kazuyuki Matsumura, Shizuoka (JP); Katsumi Gocho, Shizuoka (JP); Nobuyuki Takahashi, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/482,578

(22) Filed: Jun. 11, 2009

(30) Foreign Application Priority Data
Jun. 25, 2008 (JP) 2008-165915

(51) Int. Cl. G06K 7/10

(52) U.S. Cl. 235/472.01; 235/462.43

(57) ABSTRACT

A cable extends from a ceiling section of a unit body to a bottom section of the unit body, is wound around a lower half circumference of a pulley, and extends to the ceiling section of the unit body. A fixed end as one end of the cable is fixed to the ceiling section of the unit body. A handy scanner is connected to a free end as the other end of the cable. The ceiling section of the unit body has a passing section through which the cable passes. The pulley rotates and rises and falls between the bottom section and the ceiling section along the longitudinal direction of the unit body.

### CROSS-REFERENCE TO RELATED APPLICATION

This application is based upon and claims the benefit of priority from Japanese Patent Application No. 2008-165915, filed on Jun. 25, 2008, the entire contents of which are incorporated herein by reference.

### TECHNICAL FIELD

The present invention relates to a cable housing unit to house a cable of a handy scanner, a scanner system including a cable housing unit, a handy scanner and a vertical scanner, a checkout system including a checkout counter, and an install method.

### BACKGROUND

Hitherto, as widely used barcode scanners, there are a handy scanner (see, for example, JP-UM-A-5-18067) which is held by an operator's hand and is used, and a vertical scanner which is fixedly installed on a checkout counter and is used.

Incidentally, there is a commodity whose barcode is not easily read by the vertical scanner. For example, there is a commodity which is very heavy or very large and is difficult to be placed on a checkout counter. Then, an operator uses the handy scanner as an aid to the vertical scanner. In order to prevent the occurrence of a case where the auxiliary handy scanner does not reach the commodity, it is necessary for the cable of the auxiliary handy scanner to have such a length as to cover a distance range assumed to be used.

The operator often leaves the auxiliary handy scanner on a receiving surface of the checkout counter when it is not used. Since the cable of the auxiliary handy scanner has a considerable length, the cable may become entangled with a shopping basket or the vertical scanner. As a result, there arises a problem that the checkout operation is interrupted by the entanglement of the cable.

The problem is solved by shortening the cable length of the handy scanner. However, the distance range in which the handy scanner can be used is considerably limited.

JP-UM-A-5-18067 discloses a technique in which a rotating reel winds up a cable of a handy scanner to shorten the cable length of the handy scanner. However, the technique disclosed in JP-UM-A-5-18067 forces the operator to perform a specific operation of rotating an operation knob integral with the reel.

### SUMMARY

Accordingly, it is an object of the present invention to shorten a cable of a handy scanner without requiring a specific operation when the handy scanner is not used.

According to one aspect of the present invention, a cable housing unit includes a disk-like pulley, a unit body long in an up-and-down direction, a cable whose fixed end as one end is fixed to a ceiling section of the unit body, which extends from the fixed end to a bottom section, is wound around a lower half circumference of the pulley, extends to the ceiling section, and whose free end as the other end is connected to a handy scanner, a passing section which is bored in the ceiling section of the unit body and through which the extension portion of the cable passes, and a holding mechanism which allows the pulley to rotate and to rise and fall between the bottom section and the ceiling section along a longitudinal direction of the unit body.

According to another aspect of the present invention, a scanner system includes a vertical scanner positioned on a receiving surface of a checkout counter, a handy scanner, a cable housing unit that is arranged at one side of the vertical scanner in the checkout counter and at a position lower than the receiving surface, and includes a disk-like pulley, a unit body long in an up-and-down direction, a cable whose fixed end as one end is fixed to a ceiling section of the unit body, which extends from the fixed end to a bottom section, is wound around a lower half circumference of the pulley, extends to the ceiling section, and whose free end as the other end is connected to the handy scanner, a passing section which is bored in the ceiling section of the unit body and through which the extension portion of the cable passes, and a holding mechanism which allows the pulley to rotate and to rise and fall between the bottom section and the ceiling section along a longitudinal direction of the unit body, and a holder that is provided on the vertical scanner at a position above the cable housing unit and holds the handy scanner.

According to another aspect of the present invention, a checkout system includes a checkout counter having a receiving surface, a vertical scanner positioned on the receiving surface, a handy scanner, a cable housing unit that is arranged at one side of the vertical scanner in the checkout counter and at a position lower than the receiving surface, and includes a disk-like pulley, a unit body long in an up-and-down direction, a cable whose fixed end as one end is fixed to a ceiling section of the unit body, which extends from the fixed end to a bottom section, is wound around a lower half circumference of the pulley, extends to the ceiling section, and whose free end as the other end is connected to the handy scanner, a passing section which is bored in the ceiling section of the unit body and through which the extension portion of the cable passes, and a holding mechanism which allows the pulley to rotate and to rise and fall between the bottom section and the ceiling section along a longitudinal direction of the unit body, and a holder that is provided on the vertical scanner at a position above the cable housing unit and holds the handy scanner.

According to a further aspect of the present invention, an install method includes installing a vertical scanner on a receiving surface of a checkout counter, and installing a cable housing unit at one side of the vertical scanner in the checkout counter and at a position lower than the receiving surface, wherein the cable housing unit includes a disk-like pulley, a unit body long in an up-and-down direction, a cable whose fixed end as one end is fixed to a ceiling section of the unit body, which extends from the fixed end to a bottom section, is wound around a lower half circumference of the pulley, extends to the ceiling section, and whose free end as the other end is connected to a handy scanner, a passing section which is bored in the ceiling section of the unit body and through which the extension portion of the cable passes, and a holding mechanism which allows the pulley to rotate and to rise and fall between the bottom section and the ceiling section along a longitudinal direction of the unit body.

### DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a perspective view showing a checkout system;

FIG. 2 is a front view schematically showing the checkout system;

FIG. 3 is a perspective view showing a holder together with a handy scanner;

FIG. 4 is an outer appearance perspective view showing a cable housing unit;

FIG. 5 is a perspective view showing an attachment state of a rail member;

FIG. 6 is an outer appearance perspective view showing the cable housing unit in which a part of a unit body is cut away;

FIG. 7 is an exploded perspective view showing a pulley and a pulley cover;

FIG. 8 is a side view showing the pulley housed in the pulley cover;

FIG. 9 is a sectional view taken along line A-A of FIG. 4;

FIG. 10 is a schematic view showing an inner structure of the cable housing unit;

FIG. 11A is a side view showing the pulley positioned at a bottom section and a ceiling section; and

FIG. 11B is a front view showing the pulley positioned at the bottom section and the ceiling section.

### DETAILED DESCRIPTION

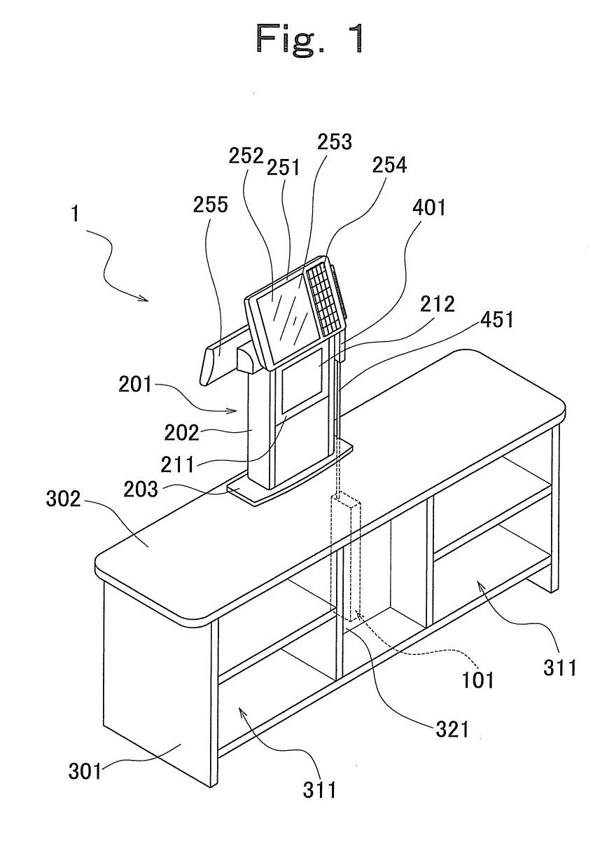

An embodiment of the present invention will be described with reference to FIG. 1 to FIG. 11.

FIG. 1 is a perspective view showing a checkout system 1. The checkout system 1 includes a laterally long table-like checkout counter 301. The checkout counter 301 has a flat receiving surface 302. A shopping basket (not shown) for containing commodities is placed on the receiving surface 302. The checkout counter 301 includes storage racks 311 to store equipments necessary for the checkout operation at both sides of the receiving surface 302 and in lower areas thereof.

The checkout counter 301 is provided with a vertical scanner 201 in a center area of the checkout counter 301 in a longitudinal direction. The vertical scanner 201 is positioned on the receiving surface 302 at the far side when seen from an operator. The vertical scanner 201 transmits and receives data to and from a POS terminal (not shown) adjacent to the checkout counter 301.

The checkout counter 301 does not have the storage rack 311 in a lower area of the receiving surface 302 where the vertical scanner 201 is arranged. The checkout counter 301 includes a panel 321 positioned in the lower area of the receiving surface 302 where the vertical scanner 201 is arranged and at a nearer side than the vertical scanner 201.

The vertical scanner 201 includes a thin rectangular scanner base 202 having a recess at an operator side and an operation section 251 at an upper part of the scanner base 202.

The operation section 251 extends to the side nearer than the front of a scanner housing 211. The operation section 251 has a downward inclined front section. The operation section 251 includes a display 253 in which a touch panel 252 is laminated on the surface thereof. The operation section 251 includes a keyboard 254 on the right and adjacent to the display 253. The operation section 251 is provided with a customer display 255 which provides information to a customer and is positioned at the back, left and far side of the operation section 251 when seen from the operator.

The vertical scanner 201 includes the thin scanner housing 211 fitted in the recess of the scanner base 202. The scanner housing 211 has a read window 212 at the front. The scanner housing 211 incorporates an illuminating LED to irradiate read light through the read window 212, a CCD image sensor to receive reflected light, and a decoder (none of them are shown) to execute a decode process on an output signal of the CCD image sensor.

The scanner base 202 passes through the receiving surface 302 and extends to the lower area of the receiving surface 302. The panel 321 conceals the extended portion of the scanner base 202.

The receiving surface 302 has a through hole (not shown) which the scanner base 202 enters. The scanner base 202 integrally has a plate-like flange section 203 extending to both sides at a halfway position in the longitudinal direction. When the scanner base 202 enters the through hole of the receiving surface 302, the receiving surface 302 supports the flange section 203.

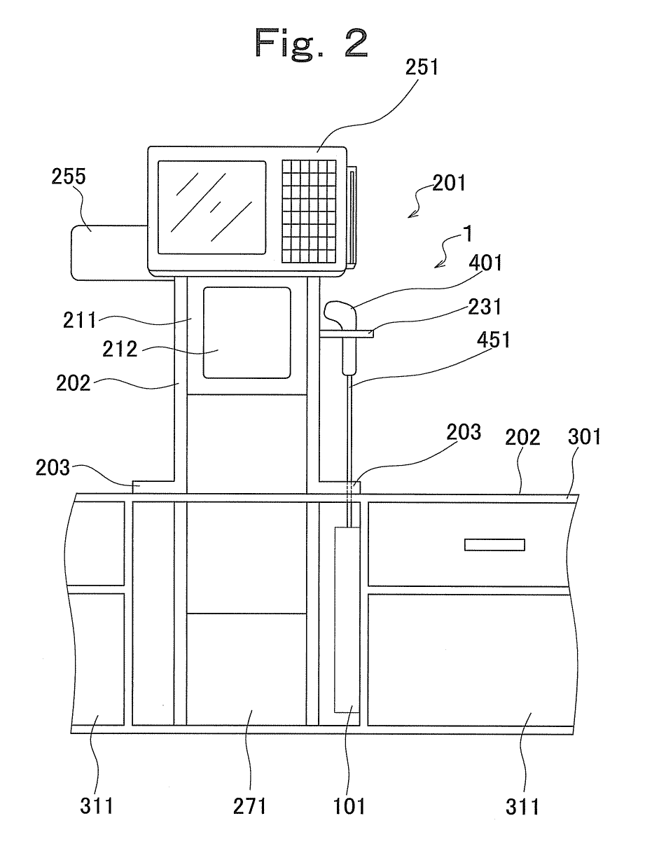

FIG. 2 is a front view schematically showing the checkout system 1. In FIG. 2, the panel 321 is removed from the checkout counter 301. The vertical scanner 201 has a plug box 271 at an extension portion to the checkout counter 301 in the scanner base 202. A vertically long cable housing unit 101 is positioned on the right side of the extension portion of the scanner base 202 when seen from the operator. The cable housing unit 101 will be described later.

A holder 231 for holding a handy scanner 401 is positioned on the right side of the scanner base 202 when seen from the operator. The scanner base 202 includes the holder 231 at a position above the cable housing unit 101. The vertical scanner 201, the handy scanner 401, the cable housing unit 101 and the holder 231 constitute a scanner system.

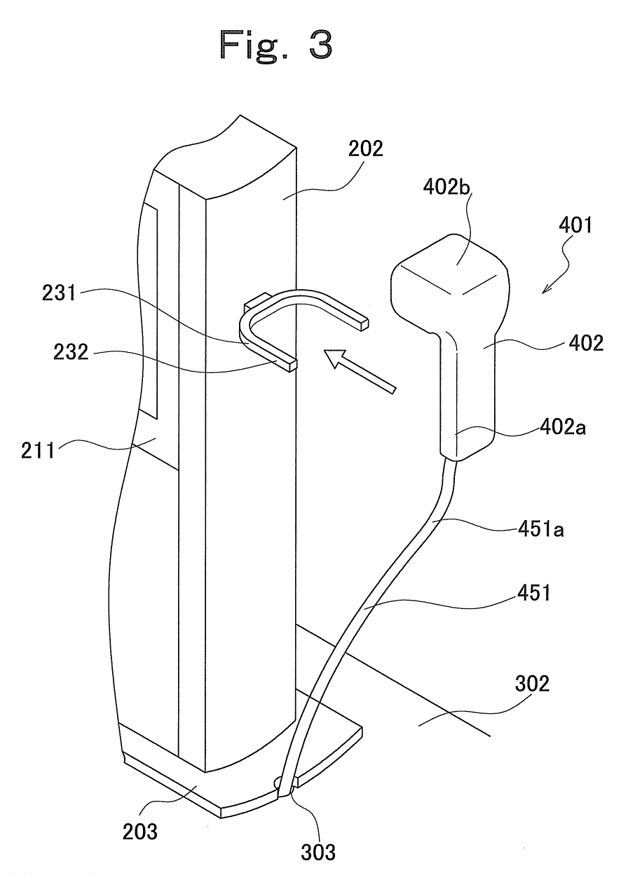

FIG. 3 is a perspective view showing the holder 231 together with the handy scanner 401.

The handy scanner 401 will be described. The handy scanner 401 includes a case 402. The case 402 includes a grip section 402a which is gripped by an operator's hand, and a reading section 402b wider than the grip section 402a. The handy scanner 401 includes a read window (not shown) at the end of the reading section 402b, which is brought close to a barcode attached to a commodity. The case 402 incorporates an illuminating LED to irradiate read light through the read window, a CCD image sensor to receive reflected light, and a decoder (none of them are shown) to execute a decode process on an output signal of the CCD image sensor.

The holder 231 includes a horizontal U-shaped section 232 having a U-shape. The U-shaped section 232 may not be horizontal. The inner width of the U-shaped section 232 is wider than the grip section 402a and narrower than the reading section 402b. The grip section 402a of the handy scanner 401 enters from an open portion of the U-shaped section 232.

The handy scanner 401 enters the U-shaped section 232 and falls by its own weight. A root portion between the grip section 402a and the reading section 402b collides with the U-shaped section 232, and the reading section 402b of the case 402 does not fall off. In this way, the holder 231 holds the handy scanner 401. The operator can easily pull out the handy scanner 401 held by the holder 231 from the open portion of the U-shaped section 232.

A cable 451 is connected to a tip of the grip section 402a. A connection end of the cable 451 to the handy scanner 401 is called a free end 451a. The cable 451 including the free end 451a is pulled out from the cable housing unit 101, and is drawn out from a receiving surface hole 303.

The receiving surface hole 303 is a part of the through hole of the receiving surface 302 which the scanner base 202 enters. The flange section 203 has a notch forming the receiving surface hole 303. The receiving surface hole 303 has a diameter larger than the cable 451. The cable 451 moves in an insertion and extraction direction with respect to the receiving surface hole 303.

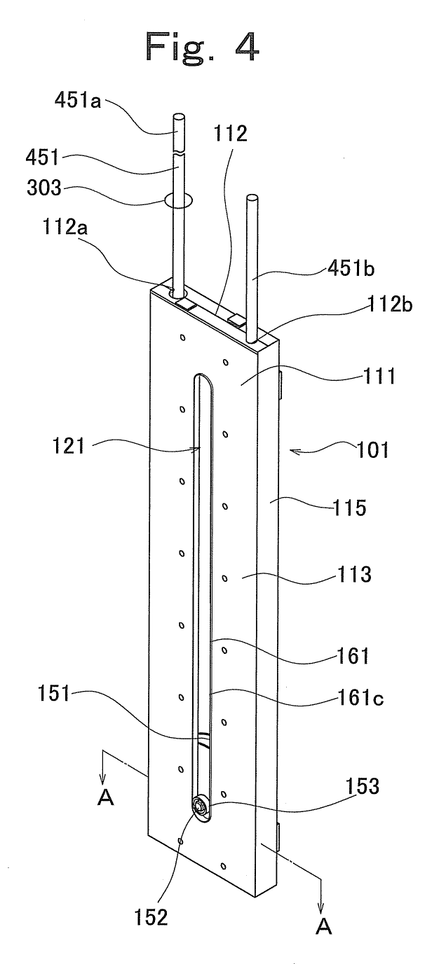

FIG. 4 is an outer appearance perspective view showing the cable housing unit 101. The cable housing unit 101 houses a halfway portion of the cable 451 between the free end 451a and a fixed end 451b as the other end. The fixed end 451b of the cable 451 is connected to the vertical scanner 201. The handy scanner 401 transmits and receives data to and from the vertical scanner 201. The fixed end 451b may be connected to a POS terminal.

The cable housing unit 101 includes a unit body 111 made of a thin rectangular metal plate long in an up-and-down direction. A body upper section 112 forming an upper surface of the unit body 111 includes a cable passing hole 112a and a cable fixing hole 112b. The free end 451a of the cable 451 is drawn out from the cable passing hole 112a. The fixed end 451b is drawn out from the cable fixing hole 112b. The cable 451 moves in the insertion and extraction direction with respect to the cable passing hole 112a. On the other hand, the cable 451 does not move in the insertion and extraction direction with respect to the cable fixing hole 112b. The fixed end 451b is a portion of the cable 451 from a portion fixed in the cable fixing hole 112b to a portion connected to the vertical scanner 201.

A body front section 113 forming the front (left lower surface in FIG. 4) of the unit body 111 has a through hole (hereinafter referred to as a rail hole 121) along the longitudinal direction (up-and-down direction) of the unit body 111. Each of both ends of the rail hole 121 is semicircular. A rail member 161 (rail 161c) as a resin mold product is attached to the rail hole 121 from the inside direction of the unit body 111.

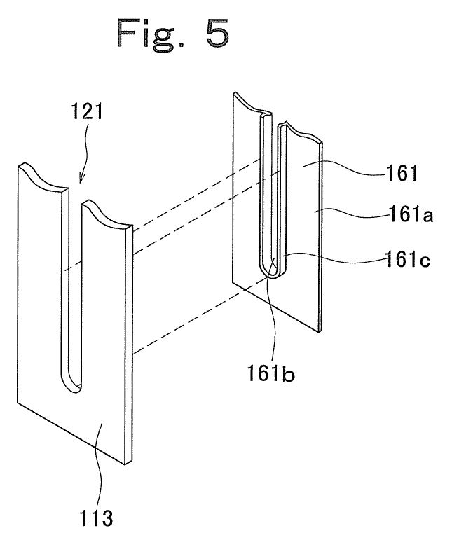

FIG. 5 is a perspective view showing an attachment state of the rail member 161. In FIG. 5, with respect to the unit body 111, only the body front section 113 is shown. In FIG. 5, the body front section 113 and the rail member 161 have cuts at upper portions.

The rail member 161 includes a flat plate section 161a of a flat plate shape. The flat plate section 161a is smaller than the outer shape of the body front section 113. Similarly to the body front section 113, the flat plate section 161a has a through hole 161b which extends along the longitudinal direction (up-and-down direction) and both ends of which are semicircular. The rail member 161 integrally includes the rail 161c which is provided around the through hole 161b and projects in a direction perpendicular to the flat plate section 161a. The rail 161c is provided along the inner peripheral shape of the rail hole 121.

The rail member 161 is attached to the body front section 113 from the inside direction of the unit body 111 in such a way that the flat plate section 161a comes in surface contact with the body front section 113, so that the projecting rail 161c is fitted in the rail hole 121. A not-shown fastening member fixes the body front section 113 to the rail member 161.

Return is made to the description of FIG. 4. A ring-shaped collar 153 as a resin mold product enters the rail 161c from the inside. The unit body 111 houses a disk-like pulley 151. Both end portions of a rotation shaft 152 as the rotation center of the pulley 151 are fitted in the collar 153. The rotation shaft 152 is rotated with respect to the pulley 151.

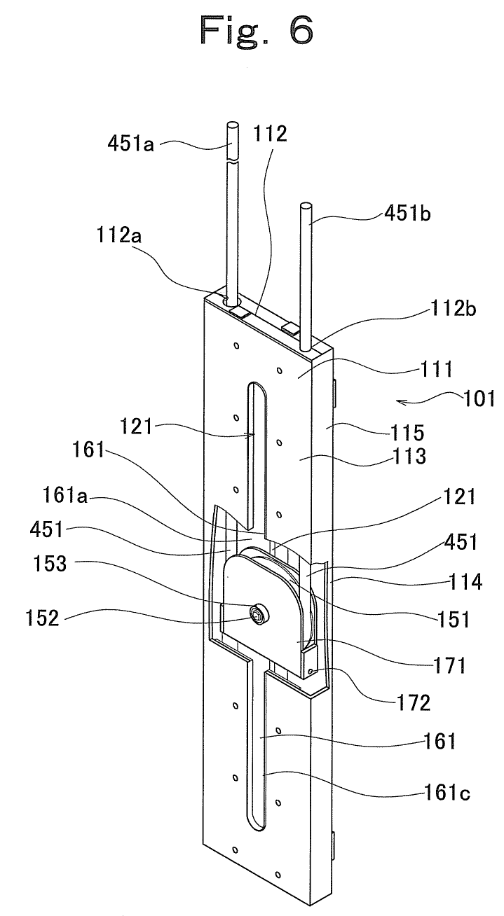

FIG. 6 is an outer appearance perspective view showing the cable housing unit 101 while a part of the unit body 111 is cut away. In FIG. 6, the pulley 151 is positioned at the center of the unit body 111 in the longitudinal direction.

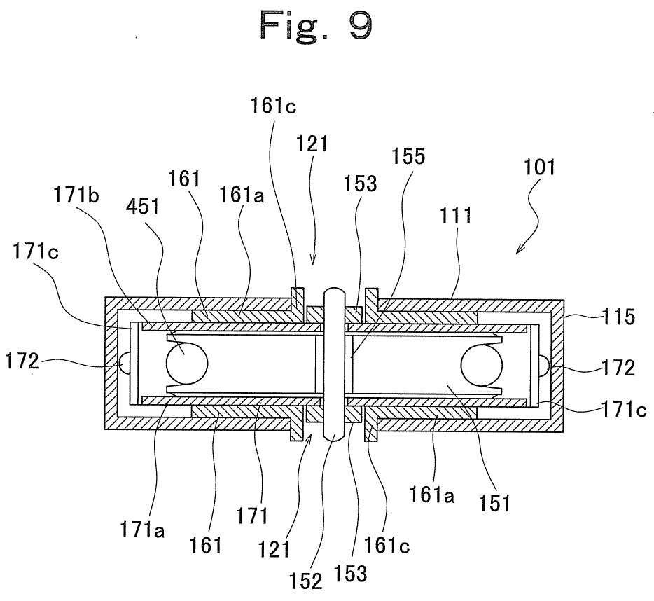

As shown in FIG. 6, a body back section 114 forming the back of the unit body 111 has a rail hole 121 corresponding to the rail hole 121 at the front side. A rail 161c is fitted also in the rail hole 121 at the back side (see FIG. 9). That is, the rail member 161 is fixedly attached also to the body back section 114 from the inside. Also in the rail hole 121 at the back side, the other collar 153 enters the rail 161c from the inside (see FIG. 9). At both the front side and the back side, the outer diameter of the collar 153 is slightly smaller than the inner width of the rail 161c to provide play therebetween.

A pulley cover 171 made of metal plate houses the pulley 151. The pulley cover 171 covers the disk surface of the pulley 151 and the lower half circumference thereof. The unit body 111 houses the pulley 151 housed in the pulley cover 171. The cable 451 is wound around the lower half circumference of the pulley 151.

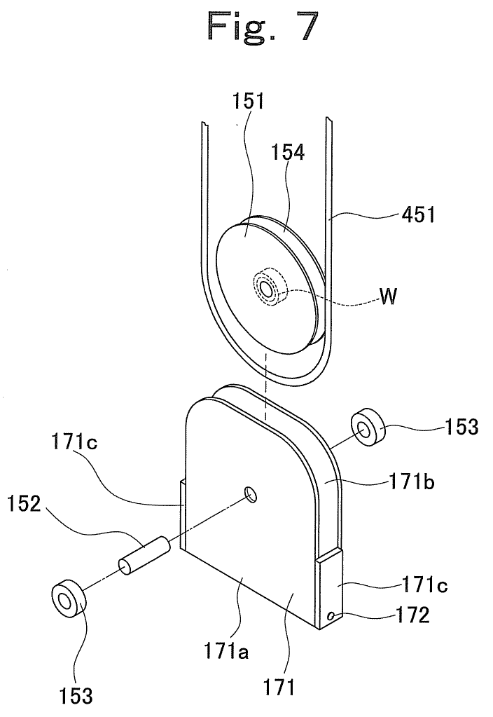

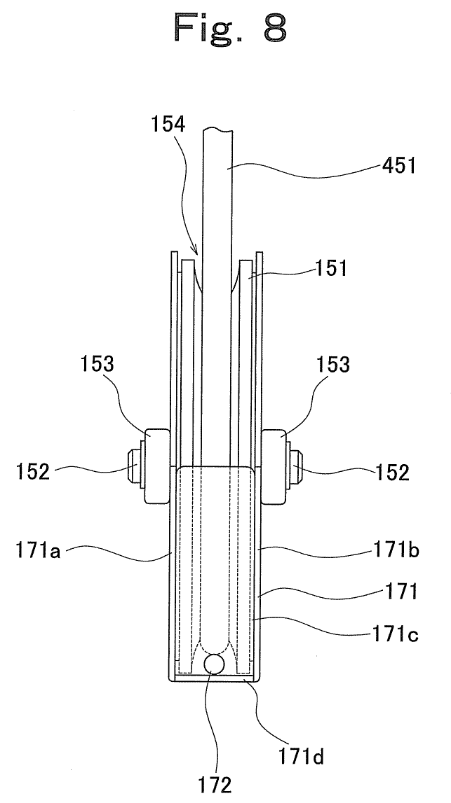

FIG. 7 is an exploded perspective view showing the pulley 151 and the pulley cover 171. FIG. 8 is a side view showing the pulley 151 housed in the pulley cover 171.

The pulley 151 has a built-in weight W having a weight of about 200 g to 250 g. The pulley 151 has a groove (hereinafter referred to as an outer circumferential groove 154) at an outer circumference, which has such a width and depth that the cable 451 can be fitted therein. The pulley cover 171 houses the pulley 151 in the state where the cable 451 is wound around the outer circumferential groove 154.

The pulley cover 171 covers the disk surface of the pulley 151 and the lower half circumference thereof as stated above. That is, the pulley cover 171 includes a cover front section 171a and a cover back section 171b which cover both the disk surfaces of the pulley 151 and a cover side section 171c which covers the lower half of the outer circumferential groove 154. Further, the pulley cover 171 includes a cover bottom section 171d which covers the bottom of the pulley 151. The pulley cover 171 exposes the upper half of the outer circumferential groove 154 of the pulley 151.

A buffer section 172 of a semicircular metal member is positioned at a position of each of both the cover side sections 171c and close to the cover bottom section 171d. The buffer section 172 will be described later.

The rotation shaft 152 is inserted into centers of the pulley cover 171 and the pulley 151. The rotation shaft 152 projects from the cover front section 171a and the cover back section 171b. The collar 153 as the resin mold product is fixedly attached to the projecting portion of the rotation shaft 152 through a not-shown bush. As shown in FIG. 8, the bottom portion of the pulley 151, which is housed in the pulley cover 171 and in which the rotation shaft 152 is inserted, is not in contact with the cover bottom section 171d.

FIG. 9 is a sectional view taken along line A-A of FIG. 4. The rotation shaft 152 is fitted in the pulley 151 through a bearing 155. Accordingly, the rotation shaft 152 is rotated with respect to the pulley 151.

As shown in FIG. 9, a gap exists between the unit body 111 and the pulley cover 171.

The flat plate section 161a attached to the inner wall of the body front section 113 is positioned in the gap between the body front section 113 and the cover front section 171a. Similarly, the flat plate section 161a attached to the body back section 114 is positioned in the gap between the body back section 114 and the cover back section 171b. The width between the pair of flat plate sections 161a is wider than the width between the cover front section 171a and the cover bottom section 171d.

The buffer section 172 fixed to the cover side section 171c is positioned in the gap between each of body side sections 115 forming both the sides of the unit body 111 and each of the cover side sections 171c. The width between the pair of body side sections 115 is wider than the width between the pair of buffer sections 172.

Accordingly, the pulley cover 171 does not contact with the unit body 111. As stated above, since the collar 153 has play relative to the rail 161c, the pulley cover 171 to house the pulley 151 rises and falls along the rail 161c in the unit body 111. That is, the pulley 151, together with the pulley cover 171, rises along the rail 161c by application of external force. When the application of external force is removed, the pulley 151, together with the pulley cover 171, falls along the rail 161c. Hereinafter, the pulley 151 housed in the pulley cover 171 will be simply referred to as “the pulley 151”.

In the rising and falling process of the pulley 151 along the rail 161c, fluctuation occurs in the position of the pulley 151. This is because the collar 153 has play relative to the rail 161c. However, even if the pulley 151 fluctuates, since the buffer section 172 comes in contact with the body side section 115, the cover side section 171c does not contact with the body side section 115.

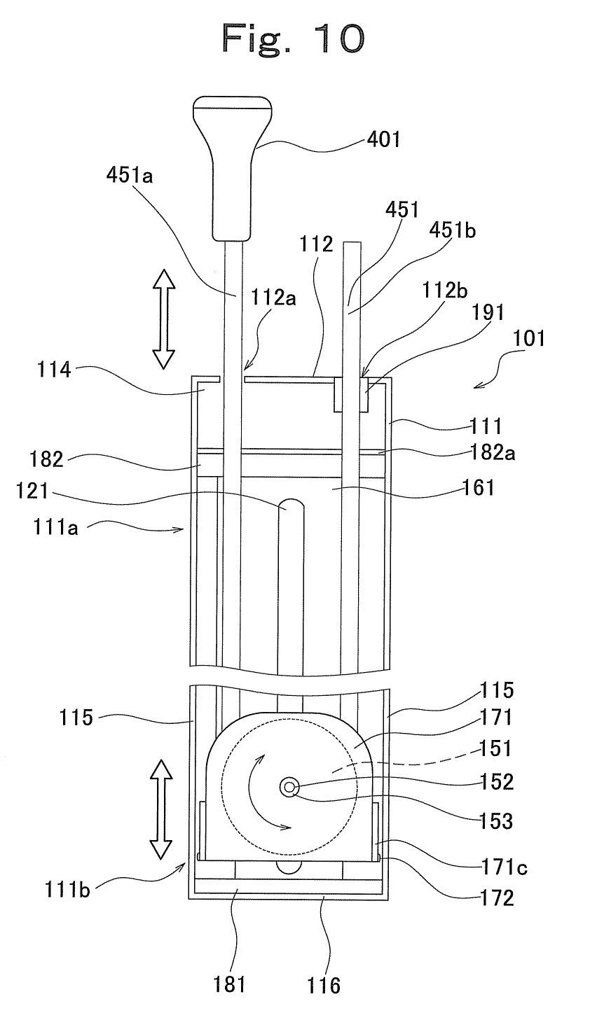

FIG. 10 is a schematic view showing an inner structure of the cable housing unit 101. The fixation of the fixed end 451b of the cable 451 is realized in such a way that the cable 451 is press inserted in a tube-like fixing member 191 fixedly provided in the cable fixing hole 112b.

A ceiling plate 182a is positioned at a position below the fixing member 191. The ceiling plate 182a crosses the inside of the unit body 111. The ceiling plate 182a has through holes having diameters larger than the cable 451 so that the free end 451a and the fixed end 451b of the cable 451 are allowed to pass through the through holes. A ceiling cushion 182 made of sponge covers the lower surface of the ceiling plate 182a. The ceiling cushion 182 has through holes corresponding to the holes of the ceiling plate 182a and having diameters larger than the cable 451. An upper end section of the unit body 111 where the ceiling cushion 182 is positioned is called a ceiling section 111a.

A bottom cushion 181 made of sponge covers an upper surface of a body bottom section 116 forming the bottom of the unit body 111. In a state where no external force is applied to the pulley cover 171, the pulley cover 171 contacts with the bottom cushion 181. A lower end section of the unit body 111 where the bottom cushion 181 is positioned is called a bottom section 111b.

The cable 451 has such a length that in the state (see FIG. 1 and FIG. 2) where the holder 231 holds the handy scanner 401, the pulley 151 is positioned on the bottom cushion 181 by its own weight.

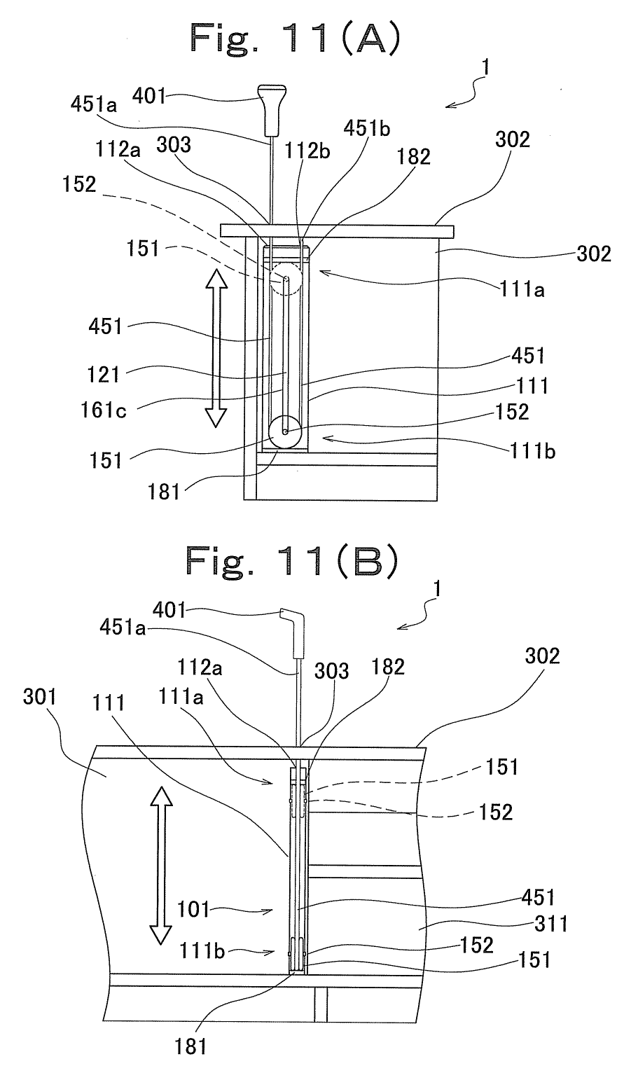

FIG. 11A is a side view showing the pulley 151 positioned at the bottom section 111b and the ceiling section 111a. FIG. 11B is a front view showing the pulley 151 positioned at the bottom section 111b and the ceiling section 111a. In FIGS. 11A and 11B, the unit body 111 is shown to be transparent and the pulley 151 positioned in the ceiling section 111a is indicated by a broken line. When the holder 231 (not shown in FIGS. 11A and 11B) holds the handy scanner 401, the pulley 151 is positioned on the bottom cushion 181 in the bottom section 111b.

In the structure as stated above, when the operator detaches the handy scanner 401 from the holder 231 and moves it away from the holder 231, the free end 451a of the cable 451 is pulled out from the cable housing unit 101, and the portion of the free end 451a side of the cable 451 housed in the unit body 111 is drawn out from the cable passing hole 112a. Since the other fixed end 451b side is fixed by the fixing member 191, the cable 451 winds up the pulley 151 on the bottom cushion 181. By the winding of the cable 451, the pulley 151 rises along the rail hole 121.

When the cable 451 winds up the pulley 151, since the pulley 151 is rotated relative to the rotation shaft 152, rotation by the friction against the cable 451 occurs. Since the rotation of the pulley 151 is caused, the drawing operation of the free end 451a is very smooth.

When the pulley 151 is wound up by the cable 451, continues to rise and reaches the ceiling section 111a, it collides with the ceiling cushion 182. The ceiling cushion 182 restricts the upward movement of the pulley 151. The ceiling cushion 182 made of sponge relaxes the shock of the vigorously colliding pulley 151. When the upward movement of the pulley 151 is restricted and room for rising is not left, the free end 451a side of the cable 451 does not operate in the drawing direction.

When the use of the handy scanner 401 is ended, the operator causes the handy scanner 401 to be held in the holder 231. Since the vertical scanner 201 includes the holder 231, the operator does not leave the handy scanner 401 on the receiving surface 302 after the use.

When the operator returns the handy scanner 401 to the holder 231, the operator releases the application of the external force to the cable 451. Then, the pulley 151 starts to fall along the rail hole 121 by its own weight. The falling pulley 151 pulls back the portion of the free end 451a side of the cable 451 extending from the cable passing hole 112a. The unit body 111 again houses the portion of the free end 451a side of the cable 451.

The falling pulley 151 reaches the bottom section 111b and collides with the bottom cushion 181. The bottom cushion 181 restricts the downward movement of the pulley 151. The bottom cushion 181 made of sponge relaxes the shock of the vigorously colliding pulley 151. When the downward movement is restricted and room for falling is not left, the pulley 151 ends the pulling back of the cable 451.

As stated above, according to the embodiment, when the operator draws out the free end 451a, the portion of the cable 451 housed in the unit body 111 is pulled out. Accordingly, the operator can move the handy scanner 401 away from the vertical scanner 201. When the handy scanner 401 is returned to the holder 231 and the drawing operation of the free end 451a in the ejection direction is ended, the unit body 111 again houses the pulled-out cable 451. That is, when the drawing of the free end 451a side connected with the handy scanner 401 is merely stopped, the operator can shorten the cable 451 without specific operation.

The cable housing unit 101 and the holder 231 may be positioned at the left side of the vertical scanner 201. Accordingly, various layouts of the checkout system 1 can be flexibly handled.

Obviously, numerous modifications and variations of the present invention are possible in light of the above teachings. It is therefore to be understood that within the scope of the appended claims, the invention may be practiced otherwise than as specifically described herein.

What is claimed is:

1. A cable housing unit, comprising:
a disk-like pulley;
a unit body long in an up-and-down direction;
a cable whose fixed end as one end is fixed to a ceiling section of the unit body, which extends from the fixed end to a bottom section, is wound around a lower half circumference of the pulley, extends to the ceiling section, and whose free end as the other end is connected to a handy scanner;
a passing section which is bored in the ceiling section of the unit body and through which the extension portion of the cable passes; and
a holding mechanism which allows the pulley to rotate and to rise and fall between the bottom section and the ceiling section along a longitudinal direction of the unit body.

2. The unit according to claim 1, further comprising:
a ceiling cushion provided at a position of the ceiling section where the rising pulley collides; and
a bottom cushion provided at a position of the bottom section where the falling pulley collides.

3. The unit according to claim 1, wherein the pulley has a built-in weight.

4. The unit according to claim 2, wherein the pulley has a built-in weight.

5. The unit according to claim 1, further comprising the handy scanner connected to the free end of the cable.

6. The unit according to claim 2, further comprising the handy scanner connected to the free end of the cable.

7. The unit according to claim 3, further comprising the handy scanner connected to the free end of the cable.

8. The unit according to claim 4, further comprising the handy scanner connected to the free end of the cable.

9. A scanner system, comprising:
a vertical scanner positioned on a receiving surface of a checkout counter;
a handy scanner;
a cable housing unit that is arranged at one side of the vertical scanner in the checkout counter and at a position lower than the receiving surface, and includes a disk-like pulley, a unit body long in an up-and-down direction, a cable whose fixed end as one end is fixed to a ceiling section of the unit body, which extends from the fixed end to a bottom section, is wound around a lower half circumference of the pulley, extends to the ceiling section, and whose free end as the other end is connected to the handy scanner, a passing section which is bored in the ceiling section of the unit body and through which the extension portion of the cable passes, and a holding mechanism which allows the pulley to rotate and to rise and fall between the bottom section and the ceiling section along a longitudinal direction of the unit body; and
a holder that is provided on the vertical scanner at a position above the cable housing unit and holds the handy scanner.

10. The system according to claim 9, further comprising:
a ceiling cushion provided at a position of the ceiling section where the rising pulley collides; and
a bottom cushion provided at a position of the bottom section where the falling pulley collides.

11. The system according to claim 9, wherein the pulley has a built-in weight.

12. The system according to claim 10, wherein the pulley has a built-in weight.

13. A checkout system, comprising:
a checkout counter having a receiving surface;
a vertical scanner positioned on the receiving surface;
a handy scanner;
a cable housing unit that is arranged at one side of the vertical scanner in the checkout counter and at a position lower than the receiving surface, and includes a disk-like pulley, a unit body long in an up-and-down direction, a cable whose fixed end as one end is fixed to a ceiling section of the unit body, which extends from the fixed end to a bottom section, is wound around a lower half circumference of the pulley, extends to the ceiling section, and whose free end as the other end is connected to the handy scanner, a passing section which is bored in the ceiling section of the unit body and through which the extension portion of the cable passes, and a holding mechanism which allows the pulley to rotate and to rise and fall between the bottom section and the ceiling section along a longitudinal direction of the unit body; and
a holder that is provided on the vertical scanner at a position above the cable housing unit and holds the handy scanner.

14. The system according to claim 13, further comprising:
a ceiling cushion provided at a position of the ceiling section where the rising pulley collides; and
a bottom cushion provided at a position of the bottom section where the falling pulley collides.

15. The system according to claim 13, wherein the pulley has a built-in weight.

16. The system according to claim 14, wherein the pulley has a built-in weight.

17. An install method, comprising:
installing a vertical scanner on a receiving surface of a checkout counter; and
installing a cable housing unit at one side of the vertical scanner in the checkout counter and at a position lower than the receiving surface, wherein the cable housing unit comprises:
a disk-like pulley;
a unit body long in an up-and-down direction;
a cable whose fixed end as one end is fixed to a ceiling section of the unit body, which extends from the fixed end to a bottom section, is wound around a lower half circumference of the pulley, extends to the ceiling section, and whose free end as the other end is connected to a handy scanner;
a passing section which is bored in the ceiling section of the unit body and through which the extension portion of the cable passes; and
a holding mechanism which allows the pulley to rotate and to rise and fall between the bottom section and the ceiling section along a longitudinal direction of the unit body.

18. The method according to claim 17, further comprising installing a holder to hold the handy scanner on the vertical scanner at a position above the cable housing unit.
